(19) United States
(12) Patent Application Publication
(10) Pub. No.: US 2003/0012476 A1
(43) Pub. Date: Jan. 16, 2003

(54) Motorcycle bearing spacer method and apparatus

(76) Inventor: Douglas Allister Biette, Caronport (CA)

Correspondence Address: John Russell Uren, P. Eng., Suite 202, 1590 Bellevue Avenue, West Vancouver, BC, V7V 1A7, CA

(21) Appl. No.: 09/907,468

(22) Filed: Jul. 16, 2001

(51) Int. Cl. F16C 19/40

(52) U.S. Cl. 384/551

(57) ABSTRACT

A spacer (113) for use in motorcycle wheels and a method of using the spacer (113) is disclosed. The spacer (113) has two members (120, 121) which are joined together by a threaded connection (124) and which may rotate relative to each other on the threaded connection (124) thereby allowing the distance between the ends (133, 134) of the two members (120, 121) to increase or decrease. The spacer (113) allows adjustment of the distance between bearings (111, 112) in the hub (100) of the motorcycle wheel.

This invention relates to a bearing spacer for use on motorcycles and, more particularly, to a bearing spacer used for the separation of the wheel bearings used on each side of the hubs used in the wheels of a motorcycle.

### BACKGROUND OF THE INVENTION

The use of spacers to separate the bearings used on the wheels of a motorcycle is well known. Typically, when work is required to be done on the wheel such as bearing grease repack or bearing replacement, the wheel must be removed from the axle. The bearings to be removed are mounted on the axle extending through the hub and contact the outer races of the hub. A spacer is mounted within the hub over the axle and has ends which bear on the inner race of each of the oppositely located bearings. The spacer is intended to provide the correct distance between the bearings such that the requisite amount of play of the hub relative to the bearings, typically 0.002-004 inch, exists when the wheel is tightened to the correct torque following installation of the bearings.

There are, however, problems with existing spacers. The existing spacers may have been compressed by a previous installation or installations which results in incorrect bearing clearances. In this event, thin shims are sometimes added to provide the additional clearance. However, during tightening or torquing of the wheel nuts, the fragile and thin shims may become damaged from the twisting torque applied during the tightening. In addition, shims of the proper size may not be readily available for various reasons resulting in the individual installing the wheel and hub being tempted to simply use incorrect clearances in the bearings in order to finish the job. If the bearing spacing is too tight, the bearings may fail prematurely. If they are too loose, wheel wobble can result. In either case, the situation is not satisfactory and safety can be compromised.

### SUMMARY OF THE INVENTION

According to one aspect of the invention, there is provided spacer apparatus for separating the bearings used on opposite sides of a hub and surrounding the circumference of an axle comprising two members having a common longitudinal axis, each of the two members bearing on an inner race of each of said bearings, said two members being movable relative to each other along said longitudinal axis to increase or decrease the distance between said oppositely located bearings.

According to a further aspect of the invention, there is provided a method of changing the distance between bearings located on opposite sides of the hub or a motorcycle wheel comprising mounting a spacer with two members movable relative to each other along a common longitudinal axis over an axle, each of said members bearing against an inner race of each of said respective bearings and moving at least one of said two members relative to said other member along said common axis thereby to increase or decrease the distance between said inner races of said respective bearings.

### BRIEF DESCRIPTION OF THE SEVERAL VIEWS OF THE DRAWINGS

A specific embodiment of the invention will now be described, by way of example only, with the use of drawings in which:

FIG. 1 is a diagrammatic cross-sectional view of a typical motorcycle hub used on the wheels of a motorcycle and particularly illustrating the bearings under the constraint of a spacer according to the prior art;

FIG. 2 is a diagrammatic cross sectional view of the hub according to FIG. 1 but illustrating the spacer according to the present invention;

FIG. 3 is an isometric view of the spacer according to the invention; and

FIGS. 4A and 4B are cross-sectional views of the male and female components of the spacer, respectively, according to the invention.

### DESCRIPTION OF SPECIFIC EMBODIMENT

Referring now to the drawings, a motorcycle wheel (not shown) is mounted on a hub 100 which hub 100, in turn, has a brake disc 101 mounted on one side as is known. An axle 102 extends through the hub 100 and brake disc 101 into the forks 103 (only one of which is shown) of the motorcycle (not illustrated). The ends 104 of the axle 102 have threaded ends and nuts 110 are threadedly connected to the axle ends 104 and torqued to the correct value to maintain the motorcycle wheel securely and properly to the motorcycle.

It is important that the wheel bearings 111, 112 be positioned correctly to tolerances within the hub 100 and that the bearings 111, 112 not be too close or too far apart relative to each other. For example, it is not advantageous to have the bearings 111, 112 too close and out of tolerance since there may be premature wear and failure of the bearings 111, 112. Likewise, if the bearings 111, 112 are too far apart and out of tolerance, there will be undesirable play of the hub 100 relative to the bearings 111, 112 which can cause a wobble in the wheel of the motorcycle thereby adversely affecting the steering and safety of the motorcycle.

To enhance the ability of correctly spacing the bearings 112, 112, a spacer according to the prior art is generally illustrated at 114. The spacer 114 is a collar type arrangement which fits over the axle 102 of the motorcycle wheel and bears on the inner races 122 of the wheel bearings 111, 112 positioned in the hub 100 of the wheel. The spacer 114 is not lengthwise adjustable and is produced to have a correct length when installed over the axle 102 and contacting the wheel bearings 111, 112. However, the spacer 114 can become compressed during use when the axle 102 is correctly or incorrectly torqued and, if the axle 102 and hub 100 are dissembled for reasons of maintenance or otherwise, the spacer 114 may not be the correct length needed for proper play between the bearings 111, 112 and the hub 100.

To assist in obtaining the correct distance between the bearings 111, 112, shims 123 are sometimes added to increase the distance between the bearings 111, 112 beyond that of the spacer 114. The shims 123, however, are vulnerable to over tightening or even tightening the axle nuts 110 during assembly. The shims 123 may tear or fold which adversely affects the integrity of the assembly and the distances between the bearings 111, 112.

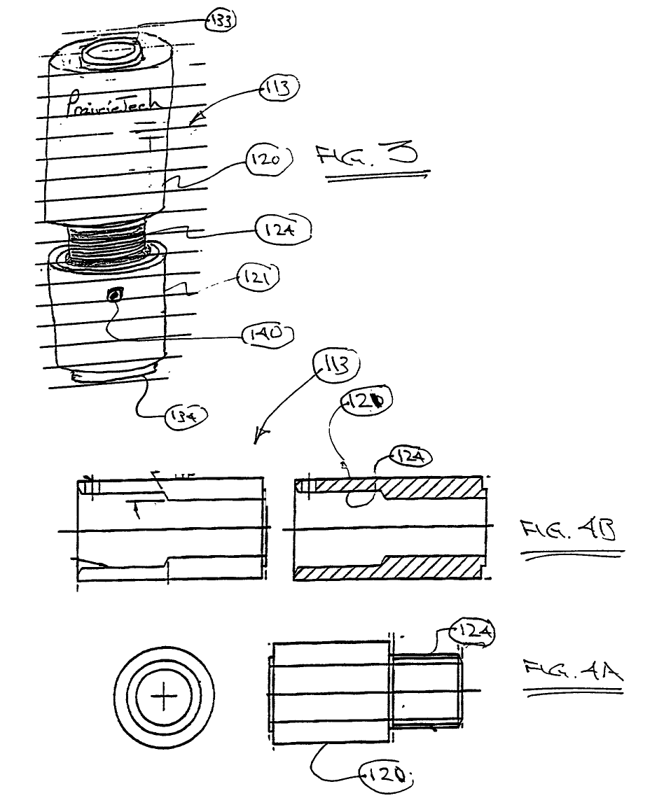

FIGS. 2 and 3 illustrate the spacer according to the present invention which is generally illustrated at 113.

Spacer 113 comprises male and female members 120, 121, respectively, which are threadedly connected in area 124 and which are, therefore, relatively movable along axis 131 to thereby increase or decrease the distance between the two ends 133, 134 of the spacer 113 which bear on the inner races 122 of the bearings 111, 112. A set screw 140 is provided to maintain the male and female members 120, 121 in their desired operating position. Each end 133, 134 of spacer 113 bears on the respective inner race 122 of each respective bearing 111, 112 mounted in the hub 100 of the wheel. It is clear the intended distance between the wheel bearings 111, 112 can be maintained with minimal difficulty, simply by rotating one of the members 120, 121 while maintaining the other of the members 120, 121, stationary and, thereafter, tightening the set screw 140 to obtain the desired distance between the two ends 133, 134.

### Operation

In operation, it will initially be assumed that the wheel (not illustrated) of the motorcycle (not illustrated) is intended to be removed from the motorcycle and that the axle 102 is intended to be removed from the hub 100 of the wheel. Typically, the distance between the bearings 111, 112 is measured before disassembly to determine the wear in the wheel 105. In this event, the axle nuts 110 are removed or loosened and the wheel 105 together with the hub 100 and bearings 122 are removed from the forks 103 of the motorcycle. At least one bearing 111, 112 is removed from the axle 102 and the axle 102, spacer 114 and remaining bearing slides outwardly and is removed from the hub 100 for the necessary rework and repair.

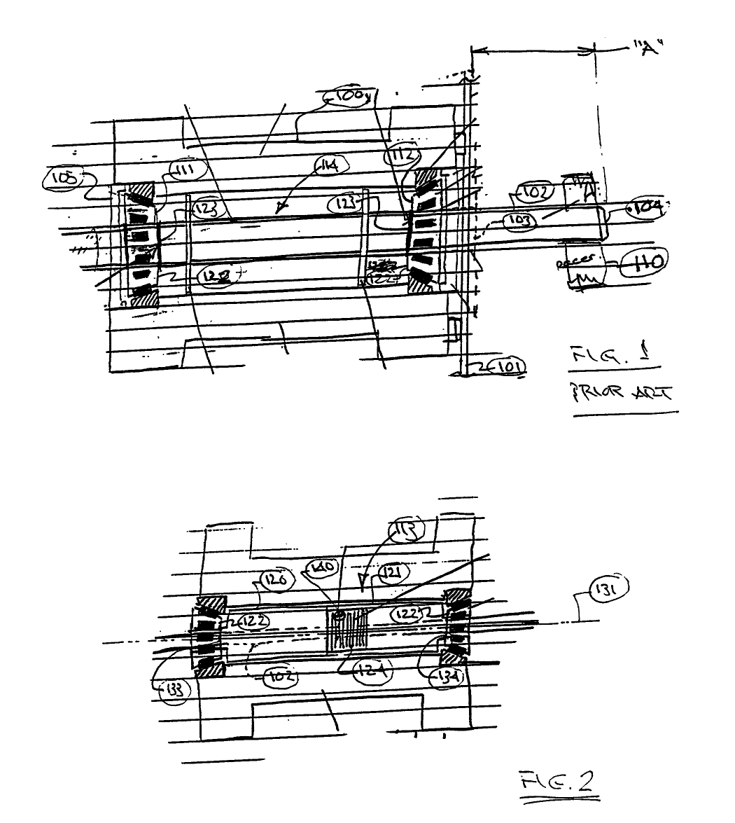

For reassembly, one of the bearings 111, 112 is mounted on the hub 100 and the spacer 113 is placed over the axle 102 on the inside of the first of the mounted bearings 111, 112. The second bearing 111, 112 is mounted on the axle 102 at the opposite end of the spacer 113 and the assembly is inserted into the hub 100. The axle 102 is mounted within the forks 103 and the nuts 110 are mounted on the ends of the axle 102. After torquing the nuts 110 to the required tightness, a caliper gage (not illustrated) measures the play in the bearings 111, 112 according to the movement of the brake disc 101 in a distance parallel to the axis 131 of the axle 102. Typically, the movement distance measured as indicated by the letter “A” in FIG. 1, will be approximately 0.002-0.004 inches. This will be within tolerances.

It will initially be assumed that the distance is only 0.001; that is, that the bearings 111, 112 are too tight in the hub 100; i.e., that they are out of tolerance. The axle 102 will be disassembled as earlier described and one of the members 120, 121 of the spacer 113 will be rotated relative to the other of the members 120, 121 to increase the length of the spacer 113 by the desired amount. Reassembly will again take place and the distance between the bearings 111, 112 again be measured. The process is continued until the proper distance is obtained.

It will be appreciated that a convenient technique and apparatus is described which allows easy and proper adjustment of the axial distance between the wheel bearings 111, 112 and which spacer 113 may be reused indefinitely. When the distance between the bearings 111, 112 is correct, the set screw 140 will be tightened and the final assembly made with the nuts 110 being finally tightened.

Spacers 113 according to the invention have been satisfactorily made from T6-6061 aluminum and the threads between the members 111, 112 are satisfactory at 32 threads/inch spacing. The set screw is a 10-32 type set screw and is made from a TEFLON like material which will not corrode or rust.

Many modifications will readily occur to those skilled in the art to which the invention relates and the embodiments described should be taken as illustrative of the invention only and not as limiting its scope as defined in accordance with the accompanying claims.

I claim:

1. Spacer apparatus (113) for separating the bearings (111, 112) used on opposite sides of a hub (100) and surrounding the circumference of an axle (102) comprising two members (120, 121) having a common longitudinal axis (131), each of the two members (120, 121) bearing on an inner race (122) of each of said bearings (111, 112), said two members (120, 121) being movable relative to each other along said longitudinal axis (131) to increase or decrease the distance between said oppositely located bearings (111, 112).

2. Spacer apparatus (113) as in claim 1 wherein said two members (120, 121) are connected with a threaded connection (124) and said relative movement is achieved by rotating one member (120, 121) relative to said other member (120, 121).

3. Spacer apparatus (113) as in claim 2 and further comprising a set screw (140) for maintaining the position of one of said members (120, 121) stationary relative to the position of said other of said members (120, 121).

4. Method of changing the distance between bearings (111, 112) located on opposite sides of the hub (100) of a motorcycle wheel comprising mounting a spacer (113) with two members (120, 121) movable relative to each other along a common longitudinal axis (131) over an axle (102), each of said members (120, 121) bearing against an inner race (122) of each of said respective bearings (111, 112) and moving at least one of said two members (120, 121) relative to said other member (120, 121) along said common axis (131) thereby to increase or decrease the distance between said inner races (122) of said respective bearings (111, 112).

5. Method as in claim 4 wherein said members (120, 121) are moved relative to each other by rotating one of said members (120, 121) relative to the other of said members (120, 121) on a threaded connection (124) between said members (120, 121).

6. Method as in claim 5 and further comprising tightening a set screw (140) to maintain said relative position of said members (120, 121).
